(19) United States
(12) Patent Application Publication
(10) Pub. No.: US 2024/0414742 A1
(43) Pub. Date: Dec. 12, 2024

(54) METHODS AND SYSTEMS FOR RESOURCE CONFIGURATION OF SIDELINK POSITIONING REFERENCE SIGNAL

(71) Applicant: ZTE Corporation, Shenzhen (CN)

(72) Inventors: Qi YANG, Shenzhen (CN); Mengzhen LI, Shenzhen (CN); Chuangxin JIANG, Shenzhen (CN); Focai PENG, Shenzhen (CN); Juan LIU, Shenzhen (CN)

(21) Appl. No.: 18/744,387

(22) Filed: Jun. 14, 2024

Related U.S. Application Data
(63) Continuation of application No. PCT/CN2022/122956, filed on Sep. 29, 2022.

(51) Int. Cl. H04W 72/25; H04W 72/0446; H04W 72/0453

(52) U.S. Cl. CPC H04W 72/25; H04W 72/0446; H04W 72/0453

(57) ABSTRACT

Techniques and methods are described for resource configuration of sidelink reference signal design. In one aspect, a method of wireless communication, comprising: determining an association between a first group of signals and a second group of signals, where the signal in the first group of signals configures/triggers/activates/indicates the signal in the second group of signals; wherein the first group of signals and the second group of signals are transmitted by a first wireless communication device to a second wireless communication device in a sidelink communication.

### CROSS-REFERENCE TO RELATED APPLICATION

This application is a continuation and claims priority to International Application No. PCT/CN2022/122956, filed on Sep. 29, 2022, the disclosure of which is hereby incorporated by reference herein in its entirety.

### TECHNICAL FIELD

This patent document is directed generally to wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

This application discloses techniques for resource configuration of sidelink reference signal.

A method of wireless communication, comprising determining an association between a first group of signals and a second group of signals, where the signal in the first group of signals configures/triggers/activates/indicates the signal in the second group of signals; wherein the first group of signals and the second group of signals are transmitted by a first wireless communication device to a second wireless communication device in a sidelink communication.

In some embodiments, the first group of signals includes sidelink control information, wherein the second group of signals includes a Sidelink Positioning Reference Signal (SL-PRS).

In some embodiments, the association is configured by gNB or UE higher layer.

In some embodiments, the association of resources occupied by the first group of signals and the second group of signals is established by configuring a plurality of pairs; wherein each of the plurality of pairs comprises one or more parameters relating to a first signal from the first group of signals and a second signal from the second group of signals.

In some embodiments, the one or more parameters comprise 1) a starting symbol of a first signal in the first group of signals, 2) a symbol number of the first signal in the first group of signal, 3) the starting symbol of a second signal in the second group of signals, 4) symbol number of the second signal in the second group of signals, 5) a starting physical resource block (PRB) of the first signal in the first group of signals, 6) a PRB number of the first signal in the first group of signals, 7) a starting PRB of the second signal in the second group of signals, 8) a comb size of the second signal in the second group of signals and/or 9) a resource bandwidth of the second signal in the second group of signals.

In some embodiments, the association of resources occupied by the first group of signals and the second group of signals can be established by configuring a list comprising a plurality of pairs: wherein each of the pairs comprises one or more parameters relating to a first signal from the first group of signals and a second signal from the second group of signals.

In some embodiments, the one or more parameters comprise 1) a starting symbol of the first signal in the first group of signals, 2) a symbol number of the first signal in the first group of signal, 3) the starting symbol of the second signal in the second group of signals, 4) symbol number of the second signal in the second group of signals, 5) a starting physical resource block (PRB) of the first signal in the first group of signals, 6) a PRB number of the first signal in the first group of signals, 7) a starting PRB of the second signal in the second group of signals, 8) a comb size of the second signal in the second group of signals and/or 9) a resource bandwidth of the second signal in the second group of signals.

In some embodiments, the association of resources occupied by the first group of signals and the second group of signals can be established by configuring a correspondence from the first group of signals to the second group of signals.

In some embodiments, the correspondence from the first group of signals to the second group of signals is determined by one or more parameters associated with the first group of signals and the second group of signals.

In some embodiments, one or more parameters comprise a group of resource information occupied by the first group of signals.

In some embodiments, each of the group of resource information occupied by the first group of signals comprises: 1) a starting symbol of a signal in the first group of signals, 2) a symbol number of a signal in the first group of signals, 3) a starting physical resource block (PRB) of a signal in the first group of signals, and/or 4) a PRB number of a signal in the first group of signals.

In some embodiments, one or more parameters comprise information related to the second group of the signals including: 1) multiplexing mode, 2) symbol offset list, 3) physical resource blocks (PRBs) offset list, 4) comb size list, 5) symbol number list, and/or 6) resource bandwidth list, wherein the multiplexing mode represents how multiple transmission signals resources in the second group of signals are multiplexed.

In some embodiments, the symbol offset list includes multiple symbol offsets, wherein each symbol offset represents the offset between a last symbol of one signal in the first group of signals and the first symbol of one signal in the second group of signals, wherein the symbol offset list has a one-to-one correspondence relationship with the group of resource information occupied by the first group of signals.

In some embodiments, the PRBs offset list includes multiple PRB offsets, wherein each PRB offset represents the offset between a starting PRB of a first symbol of one signal in the first group of signals and the starting PRB of the first symbol of one signal in the second group of signals, wherein the PRB offset list has a one-to-one correspondence relationship with the group of resource information occupied by the first group of signals.

In some embodiments, comb size list includes multiple comb size, wherein each comb size represents a resource element spacing in each symbol of one signal resource in the second group of signals, wherein the elements in the comb size list has a one-to-one correspondence relationship with the group of resource information occupied by the first group of signals.

In some embodiments, symbol number list includes multiple symbol numbers, wherein each symbol number represents the number of symbols occupied by one signal in the second group of signals in a slot, wherein the symbol number list has a one-to-one correspondence relationship with the group of resource information occupied by the first group of signals.

In some embodiments, resource bandwidth list includes multiple resource bandwidth, wherein each resource bandwidth represents the number of PRBs allocated for one signal in the second group of signals, wherein the resource bandwidth list has a one-to-one correspondence relationship with the group of resource information occupied by the first group of signals.

In some embodiments, the association of resources occupied by the first group of signals and the second group of signals can be established by configuring a correspondence from the second group of signals to the first group of signals, where resources occupied by the first group of signals are inferred from resources occupied by the second group of signals.

In some embodiments, the correspondence from the second group of signals to the first group of signals is determined by one or more parameters associated with the second group of signals and the first group of signals.

In some embodiments, one or more parameters comprise a group of resource information occupied by the second group of signals.

In some embodiments, each of the group of resource information occupied by the second group of signals comprises: 1) a starting symbol of a signal in the second group of the signals, 2) symbol number of a signal in the second group of signals, 3) a starting physical resource block (PRB) of a signal in the second group of signals, 4) comb size of a signal in the second group of signals, and/or 5) resource bandwidth of a signal in the second group of signals.

In some embodiments, one or more parameters comprise information related to the first group of the signals including: 1) symbol offset list, 2) physical resource blocks (PRBs) offset list, 3) symbol number list, and/or 4) PRB number list.

In some embodiments, symbol offset list includes multiple symbol offsets, wherein each symbol offset represents the symbol offset between the first symbol of one signal in the first group of signals and the first symbol of one signal in the second group of signals, wherein the symbol offset list has a one-to-one correspondence relationship with the group of resource information occupied by the second group of signals.

In some embodiments, physical resource blocks (PRBs) offset list includes multiple PRB offsets, wherein each PRB offset represents the offset between a starting PRB of the first symbol of one signal in the second group of signals and the starting PRB of the first symbol of one signal in the first group of signals, wherein the PRB offset list has a one-to-one correspondence relationship with the group of resource information occupied by the second group of signals.

In some embodiments, symbol number list includes multiple symbol numbers, wherein each symbol number represents the number of symbols occupied by one signal in the first group of signals in a slot, wherein the symbol number list has a one-to-one correspondence relationship with the group of resource information occupied by the second group of signals.

In some embodiments, PRB number list includes multiple PRB numbers, wherein each PRB number represents the PRB number occupied by one signal in the first group of signals in a slot, wherein the PRB number list has a one-to-one correspondence relationship with the group of resource information occupied by the second group of signals.

In some embodiments, a signal in the first group of signals can carry control information comprising: 1) priority of the association signal in the second group of signals, 2) periodicity of the association signal in the second group of signals, 3) repetition of the association signal in the second group of signals, and 4) reservation resource.

In some embodiments, one signal in the first group of signals and one associated signal in the second group of signals are transmitted together with a third signal based on transmission powers of the signal in the first group of signals and the associated signal in the second group of signals.

In some embodiments, the third signal includes the signal used for Automatic Gain Control (AGC).

In some embodiments, the third signal is determined transmitted in a mode occupying frequency resources based on a frequency pattern of the signal in the second group of signals.

In some embodiments, the mode is designed to be a duplicate of a first symbol of the signal in the second group of signals if the signal in the second group of signals are transmission with fully staggered frequency pattern; wherein the mode is designed to be a duplicate of an expected symbol next to a final symbol of the signal in the second group of signals if the signal in the second group of signals are transmission with partial staggered frequency pattern.

In some embodiments, the expected symbol next to a final symbol of the signal in the second group of signals is determined by a comb pattern of the signal in the second group of signals.

In some embodiments, frequency resources occupied by the first group of signals can be limited to a range, where the range is less than bandwidth of the second group of signals.

In some embodiments, a frequency range of the first group of signals in time domain slot t can be determined based on 1) a frequency range of the first group of signals in time domain slot t−1, and/or 2) a parameter K, wherein K is larger or equals to 0.

In some embodiments, the frequency range of the first group of signals in time domain slot t and the frequency range of the first group of signals in time domain slot t−1 have no overlap.

In some embodiments, K indicates a distance between a boundary of the frequency range of the first group of signals in time domain slot t and a boundary of the frequency range of the first group of signals in time domain slot t−1.

In some embodiments, K has a unit of physical resource block (PRB), resource element (RE), a sub-channel, and/or a frequency range.

In some embodiments, the association of transmission power for transmitting the first group of signals and the second group of signals can be established by configuring an offset parameter delta, wherein the offset parameter delta is larger or equals to 0.

In some embodiments, offset parameter delta is configured by a base station or a UE.

In some embodiments, power spectrum density (PSD) of the transmission power for transmitting a first group of signals is same as the PSD of the transmission power for transmitting a second group of signals, if the offset parameter delta is configured as 0.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example of multiple SL-PRS transmission in dedicated resource pool.

FIG. 2 shows an example of a slot structure with AGC between SCI and SL-PRS.

FIG. 3 shows an example of a slot structure with no AGC between SCI and SL-PRS.

FIG. 4 shows an example of AGC design where multiple SL-PRS with fully staggered pattern is multiplexed in FDM.

FIG. 5 shows an example of AGC design, where multiple SL-PRS with partially staggered pattern is multiplexed in FDM.

FIG. 6 shows an example of AGC design, where multiple SL-PRS with fully staggered pattern is multiplexed in TDM.

FIG. 7 shows an example of AGC design, where multiple SL-PRS with partially staggered pattern is multiplexed in TDM.

FIG. 8 shows an example of SCI hopping with K>0.

FIG. 9 shows an example SCI hopping with K=0.

FIG. 10 shows an exemplary block diagram of a hardware platform that may be a part of a network device or a communication device.

FIG. 11 shows an example of wireless communication including a base station (BS) and user equipment (UE) based on some implementations of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

### Initial Comments

In sidelink positioning, sidelink positioning reference signal (SL-PRS) is transmitted by anchor nodes to target user equipment (UE) via PC5 interface. Based on a SL-PRS, a target UE can obtain location measurements. Then, wireless dependent positioning solutions can be employed to calculate the location estimation of the target UE. In some sidelink positioning, there may exist cases that multiple transmission SL-PRS is multiplexed in one slot. However, there is a problem about how to configure the resource for multiple transmission SL-PRS.

### Introduction to Embodiments

### Embodiment 1

There are two main options for sidelink positioning reference signal (SL-PRS) transmission and reception resource design.

One option is to multiplex SL-PRS with physical sidelink shared channel (PSSCH) in the SL communication resource pool. Positioning accuracy is dependent on bandwidth of SL-PRS when time-based positioning methods are used. In the shared resource pool, the bandwidth of SL-PRS is limited to PSSCH bandwidth, which results in positioning performance not satisfying requirements.

Another option is to design the dedicated resource pool for SL-PRS, separately from SL communication resource pool (e.g., the resource pool for PSSCH). In the dedicated resource pool, transmission and reception of SL-PRS are more flexible.

This disclosure focuses on SL-PRS resource design and configuration in the dedicated resource pool.

For SL-PRS resource configuration and SL-PRS transmission, sidelink control information (SCI) is used to configure/trigger/activate SL-PRS. Besides, automatic gain control (AGC) and gap symbol are adopted such that AGC is used to adjust power and the gap symbol is set to switch transmission and reception. Thus, the dedicated resource pool comprises SL-PRS resource, SCI, AGC and/or gap symbol(s).

Under the scenario that there are multiple SL-PRS transmission in one slot, multiple SL-PRS can multiplex in the dedicated resource pool. The multiplex adopted by SL-PRS resources can be through either frequency division multiplexing (FDM) manner or through time division multiplexing (TDM) manner. Each SL-PRS can be configured/triggered/activated by one SCI. Number of SCI relies on SL-PRS number, where number of SCI is same as SL-PRS number.

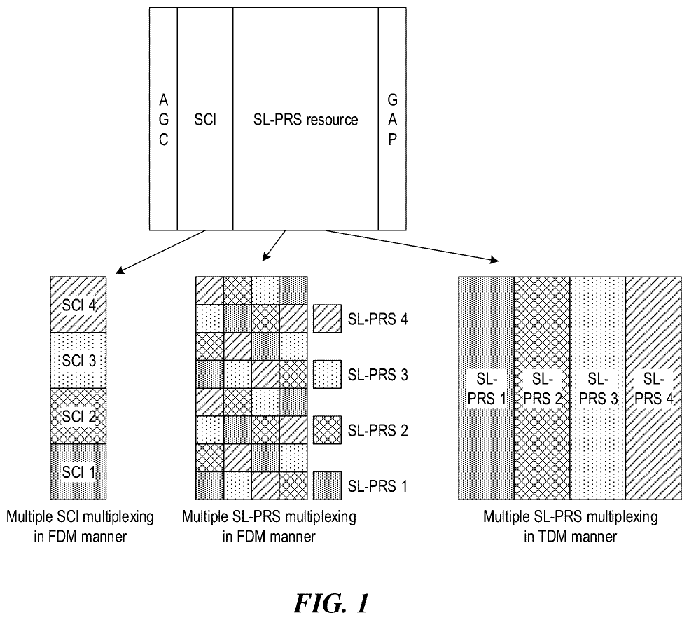

Multiple SCI can multiplex in FDM manner. An illustration of multiple SL-PRS transmission in the SL-PRS dedicated resource pool is shown in FIG. 1. Each SCI configures/triggers/activates/indicates one SL-PRS. The mapping between SCI and its associated SL-PRS can be established by gNB/UE higher layer.

### Proposed Solution 1:

One proposed solution to establish the mapping between SCI and the associated SL-PRS is to configure multiple pairs of SCI and associated SL-PRS by gNB.

When the mapping between SCI and its associated SL-PRS is configured by gNB, the SL-PRS resource configuration procedure can be as the following:

At least the following information should be configured by gNB higher layer signaling (e.g., radio resource control (RRC)).

In particular, multiple pairs of SCI and associated SL-PRS: Each pair of SCI and its associated SL-PRS should include at least the following information: starting symbol of SCI, number of symbols of SCI, starting PRB of SCI, PRB number of SCI, starting symbol of associated SL-PRS, number of symbols of associated SL-PRS, starting PRB of associated SL-PRS, comb size of associated SL-PRS, and/or resource bandwidth of associated SL-PRS.

The above information is transmitted to a UE by downlink control information (DCI) and/or physical downlink shared channel (PDSCH).

UE can select one pair of SCI and associated SL-PRS from multiple configured pairs.

### Proposed Solution 2.

Alternatively, another solution to establish the mapping between SCI and the association SL-PRS is to configure a pair list composed with multiple pairs of SCI and association SL-PRS by gNB.

When the mapping between SCI and its associated SL-PRS is configured by gNB, the SL-PRS resource configuration procedure can be following:

At least the following information should be configured by gNB higher layer signaling (e.g., RRC):

A pair list of SCI and associated SL-PRS: includes multiple pairs, where one pair is the couple of SCI and associated SL-PRS. Each pair of SCI and its associated SL-PRS should include at least the following information: starting symbol of SCI, number of symbols of SCI, starting PRB of SCI, PRB number of SCI, starting symbol of associated SL-PRS, number of symbols of associated SL-PRS, starting PRB of associated SL-PRS, comb size of associated SL-PRS, and/or resource bandwidth of associated SL-PRS.

The above information is transmitted to UE by DCl/PDSCH.

UE can select one pair of SCI and associated SL-PRS from the configured pair list.

### Proposed Solution 3.

Alternatively, another solution to establish the mapping between SCI and the association SL-PRS is to configure the correspondence between SCI parameters and SL-PRS parameters by gNB.

When the mapping between SCI and its associated SL-PRS is configured by gNB, the SL-PRS resource configuration procedure can be following:

At least the following information should be configured by gNB higher layer signaling (e.g., RRC):
1) A SCI resource list: includes multiple SCI resource. Each SCI resource includes at least the following information: starting symbol of SCI, number of symbols of SCI, starting PRB of SCI, PRB number of SCI.
2) Multiplexing mode of SL-PRS: indicates how multiple SL-PRS transmission resource is multiplexed, in FDM manner or in TDM manner.
3) Symbol offset list of SL-PRS: includes multiple symbol offsets, where each symbol offset indicates the offset between the last symbol of SCI and the first symbol of the associated SL-PRS. There is a one-to-one correspondence between the SCI resource list and the symbol offset list of SL-PRS.
4) PRB offset list of SL-PRS: If multiplexing mode of SL-PRS indicates FDM, the PRB offset list of SL-PRS includes multiple PRB offsets, where each PRB offset indicates the offset between the starting PRB of the first symbol of SCI and the starting PRB of the first symbol of the associated SL-PRS. There is a one-to-one correspondence between the SCI resource list and the PRB offset list of SL-PRS. If multiplexing mode of SL-PRS indicates TDM, the PRB offset list of SL-PRS is empty.
5) Comb size list of SL-PRS: includes multiple comb size, where each comb size indicates resource element spacing in each symbol of the SL-PRS resource. There is a one-to-one correspondence between the SCI resource list and the comb size list of SL-PRS.
6) Symbols number list of SL-PRS: includes multiple symbols number, where each symbols number indicates the number of symbols occupied by SL-PRS in a slot. There is a one-to-one correspondence between the SCI resource list and the symbols number list of SL-PRS.
7) Resource bandwidth list of SL-PRS: includes multiple resource bandwidth, where each resource bandwidth indicates the number of PRBs allocated for the associated SL-PRS. There is a one-to-one correspondence between the SCI resource list and the resource bandwidth list of SL-PRS.

The above information is transmitted to UE by DCI/PDSCH.

UE selects one SCI in the SCI resource list, then associated SL-PRS resource can be determined according to symbol offset list of SL-PRS, PRB offset list of SL-PRS, comb size list of SL-PRS and symbols number list of SL-PRS.

### Proposed Solution 4

Alternatively, when the mapping between SCI and its associated SL-PRS is configured by gNB, the SL-PRS resource configuration procedure can be following for configuring correspondence between SCI parameters and SL-PRS parameters:

At least the following information should be configured by gNB higher layer signaling (e.g., RRC):

A SL-PRS resource list: includes multiple SL-PRS resource. Each SL-PRS resource includes at least the following information: starting symbol of SL-PRS, symbols number of SL-PRS, starting PRB of SL-PRS, comb size of SL-PRS, resource bandwidth of SL-PRS.

Symbol offset list of SCI: includes multiple symbol offsets, where each symbol offset indicates the symbol offset between the first symbol of SL-PRS and the first symbol of the associated SCI. There is a one-to-one correspondence between the SL-PRS resource list and the symbol offset list of SCI.

PRB offset list of SCI: includes multiple PRB offsets, where each PRB offset indicates the offset between the starting PRB of the first symbol of SL-PRS and the starting PRB of the first symbol of associated SCI. There is a one-to-one correspondence between the SL-PRS resource list and the PRB offset list of SCI.

Symbols number list of SCI: includes multiple symbols number, where each symbols number indicates the number of symbols occupied by SCI in a slot. There is a one-to-one correspondence between the SL-PRS resource list and the symbols number list of SCI.

PRB number list of SCI: includes multiple PRB numbers, where each PRB number indicates the PRB number occupied by SCI in a slot. There is a one-to-one correspondence between the SL-PRS resource list and the PRB number list of SCI.

The above information is transmitted to UE by DCI/PDSCH.

UE can select one or more transmission SL-PRS in the SL-PRS resource list, then the associated SCI can be determined according to symbol offset list of SCI, PRB offset list of SCI, symbols number list of SCI, PRB number list of SCI.

### Proposed Solution 5

Another solution to establish the mapping between SCI and the associated SL-PRS is to configure multiple pairs of SCI and associated SL-PRS by UE higher layer.

When the mapping between SCI and its associated SL-PRS is preconfigured by UE higher layer, the SL-PRS resource configuration procedure is following:

At least the following information should be configured by UE higher layer:

Multiple pairs of SCI and associated SL-PRS: Each pair of SCI and its associated SL-PRS should include at least the following information: starting symbol of SCI, number of symbols of SCI, starting PRB of SCI, PRB number of SCI, starting symbol of associated SL-PRS, number of symbols of associated SL-PRS, starting PRB of associated SL-PRS, comb size of associated SL-PRS, and/or resource bandwidth of associated SL-PRS

UE can select one pair of SCI and associated SL-PRS from multiple preconfigured pairs.

### Proposed Solution 6

Alternatively, another solution to establish the mapping between SCI and the association SL-PRS is to configure a pair list composed with multiple pairs of SCI and association SL-PRS by UE higher layer.

When the mapping between SCI and its associated SL-PRS is preconfigured by UE higher layer, the SL-PRS resource configuration procedure can be following:

At least the following information should be configured by UE higher layer:

A pair list of SCI and associated SL-PRS: includes multiple pairs, where one pair is the couple of SCI and associated SL-PRS. Each pair of SCI and its associated SL-PRS should include at least the following information: starting symbol of SCI, number of symbols of SCI, starting PRB of SCI, PRB number of SCI, starting symbol of associated SL-PRS, number of symbols of associated SL-PRS, starting PRB of associated SL-PRS, comb size of associated SL-PRS, resource bandwidth of associated SL-PRS

UE can select one pair of SCI and associated SL-PRS from the preconfigured pair list.

### Proposed Solution 7

Alternatively, another solution to establish the mapping between SCI and the association SL-PRS is to configure the correspondence between SCI parameters and SL-PRS parameters by UE higher layer. When the mapping between SCI and its associated SL-PRS is preconfigured by UE higher layer, the SL-PRS resource configuration procedure can be following:

At least the following information should be configured by UE higher layer:
1) A SCI resource list: includes multiple SCI resource. Each SCI resource includes at least the following information: starting symbol of SCI, number of symbols of SCI, starting PRB of SCI, PRB number of SCI.
2) Multiplexing mode of SL-PRS: indicates how multiple SL-PRS transmission resource is multiplexed, in FDM manner or in TDM manner.
3) Symbol offset list of SL-PRS: includes multiple symbol offsets, where each symbol offset indicates the offset between the last symbol of SCI and the first symbol of the associated SL-PRS. There is a one-to-one correspondence between the SCI resource list and the symbol offset list of SL-PRS.
4) PRB offset list of SL-PRS: If multiplexing mode of SL-PRS indicates FDM, the PRB offset list of SL-PRS includes multiple PRB offsets, where each PRB offset indicates the offset between the starting PRB of the first symbol of SCI and the starting PRB of the first symbol of the associated SL-PRS. There is a one-to-one correspondence between the SCI resource list and the PRB offset list of SL-PRS. If multiplexing mode of SL-PRS indicates TDM, the PRB offset list of SL-PRS is empty.
5) Comb size list of SL-PRS: includes multiple comb size, where each comb size indicates resource element spacing in each symbol of the SL-PRS resource. There is a one-to-one correspondence between the SCI resource list and the comb size list of SL-PRS.
6) Symbols number list of SL-PRS: includes multiple symbols number, where each symbols number indicates the number of symbols occupied by SL-PRS in a slot. There is a one-to-one correspondence between the SCI resource list and the symbols number list of SL-PRS.
7) Resource bandwidth list of SL-PRS: includes multiple resource bandwidth, where each resource bandwidth indicates the number of PRBs allocated for the associated SL-PRS. There is a one-to-one correspondence between the SCI resource list and the resource bandwidth list of SL-PRS.

UE selects one SCI in the SCI resource list, then associated SL-PRS resource can be determined according to symbol offset list of SL-PRS, PRB offset list of SL-PRS, comb size list of SL-PRS and symbols number list of SL-PRS.

### Proposed Solution 8

Alternatively, when the mapping between SCI and its associated SL-PRS is preconfigured by UE higher layer, the SL-PRS resource preconfiguration procedure can be following for preconfiguring correspondence between SCI parameters and SL-PRS parameters:

At least the following information should be configured by UE higher layer:
1) A SL-PRS resource list: includes multiple SL-PRS resource. Each SL-PRS resource includes at least the following information: starting symbol of SL-PRS, symbols number of SL-PRS, starting PRB of SL-PRS, comb size of SL-PRS, resource bandwidth of SL-PRS.
2) Symbol offset list of SCI: includes multiple symbol offsets, where each symbol offset indicates the symbol offset between the first symbol of SL-PRS and the first symbol of the associated SCI. There is a one-to-one correspondence between the SL-PRS resource list and the symbol offset list of SCI.
3) PRB offset list of SCI: includes multiple PRB offsets, where each PRB offset indicates the offset between the starting PRB of the first symbol of SL-PRS and the starting PRB of the first symbol of associated SCI. There is a one-to-one correspondence between the SL-PRS resource list and the PRB offset list of SCI.
4) Symbols number list of SCI: includes multiple symbols number, where each symbols number indicates the number of symbols occupied by SCI in a slot. There is a one-to-one correspondence between the SL-PRS resource list and the symbols number list of SCI.
5) PRB number list of SCI: includes multiple PRB numbers, where each PRB number indicates the PRB number occupied by SCI in a slot. There is a one-to-one correspondence between the SL-PRS resource list and the PRB number list of SCI.

UE selects one or more transmission SL-PRS in the SL-PRS resource list, then the associated SCI can be determined according to symbol offset list of SCI, PRB offset list of SCI, symbols number list of SCI, PRB number list of SCI.

When UE transmits SL-PRS, the coupled SCI also should be transmitted. And the SCI should carry at least the following information: priority of transmission SL-PRS, periodicity of transmission SL-PRS, repetition of transmission SL-PRS, reservation resource.

For SL-PRS resource allocation, gNB can uniformly schedule and allocate SL-PRS transmission resource in multiple pairs of SCI and associated SL-PRS for multiple UEs, without transmission collision.

When there is no gNB or gNB does not allocate SL-PRS resource, UE autonomous SL-PRS resource allocation is needed.

The scheme of UE autonomous SL-PRS resource allocation is similar to UE autonomous PSSCH resource allocation. UE need to monitor SCI from other UEs in sensing window. If UE receives a SCI in sensing window, it decodes the received SCI and obtains the received priority. According to the received priority and the transmitted priority, the RSRP threshold can be obtained.

If the RSRP measurement of the received SCI is higher than RSRP threshold, the coupled SL-PRS resource and the reserved resource of the received SCI can be precluded.

Alternatively, if the RSRP measurement of the received SCI is lower than RSRP threshold, the coupled SL-PRS resource and the reserved resource of the received SCI can be included.

### Embodiment 2

Based on the disclosure in Embodiment 1, for a slot structure with multiple SL-PRS transmission, AGC and gap symbol can be considered to adjust power and switch transmission and reception.

After SL-PRS transmission, one symbol should be configured as gap, to switch transmission and reception.

Before SCI transmission, one symbol should be configured as AGC to adjust transmission power.

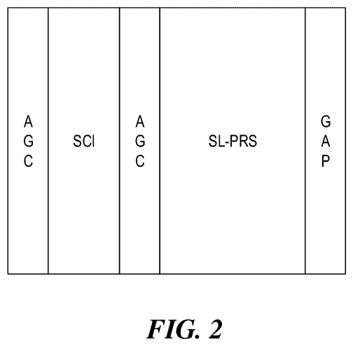

FIG. 2 discloses a scenario that one symbol is used as AGC when transmission power of transmission SL-PRS is different from transmission power of SCI.

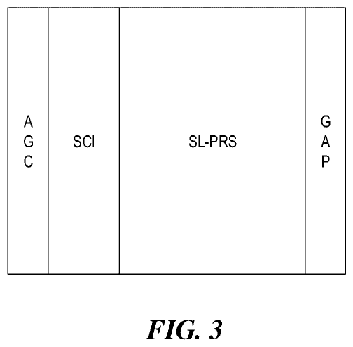

FIG. 3 discloses a scenario that AGC is not needed between SCI and SL-PRS when transmission power of transmission SL-PRS is same as transmission power of SCI.

If AGC between SCI and SL-PRS exists, the symbol of AGC can be a duplication of one symbol of SL-PRS.

For transmission SL-PRS with fully staggered frequency pattern, the symbol of AGC is a duplication of the first symbol of transmission SL-PRS.

For transmission SL-PRS with partially staggered frequency pattern, the symbol of AGC is a duplication of the expected symbol next to the final symbol of transmission SL-PRS obtained by comb pattern of transmission SL-PRS.

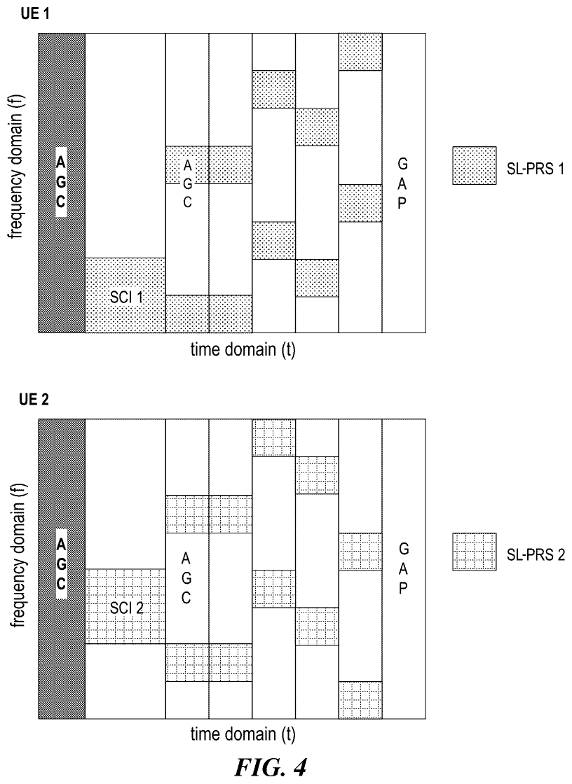

Under multiple transmission SL-PRS with fully staggered pattern is multiplexed in FDM manner, FIG. 4 discloses an example of AGC design in a situation where two transmission SL-PRS of two UEs is multiplexed in FDM manner and comb size of both the two SL-PRS are 4.

As disclosed in FIG. 4, UE1 transmits SL-PRS in SL-PRS resource 1, and UE2 transmits SL-PRS in SL-PRS resource 2. Because both of SL-PRS1 and SL-PRS2 are fully staggered, AGC symbol transmitted by UE1 is a duplication of the first symbol of SL-PRS1. and AGC symbol transmitted by UE2 is a duplication of the first symbol of SL-PRS2.

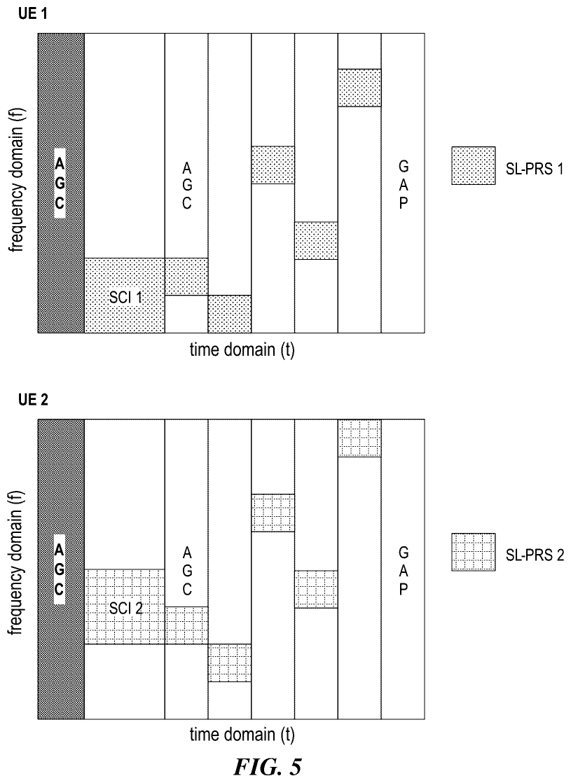

Under multiple transmission SL-PRS with partially staggered frequency pattern is multiplexed in FDM manner, FIG. 5 discloses an illustration of AGC design, where two transmission SL-PRS of two UEs is multiplexed in FDM manner and comb size of both the two SL-PRS are 8.

As disclosed in FIG. 5, UE1 transmits SL-PRS in SL-PRS resource 1, and UE2 transmits SL-PRS in SL-PRS resource 2. Both of SL-PRS1 and SL-PRS2 are partially staggered pattern in frequency domain.

For UE1, SL-PRS1 occupies four symbols and RE #0, #4, #2, #6. If there has the fifth symbol, the occupied RE in the fifth symbol is RE #1 obtained according to comb pattern with comb size 8. Thus, the AGC symbol between SCI1 and SL-PRS1 of UE1 should be a duplication of the fifth symbol.

For UE2, SL-PRS2 occupies four symbol and RE #1, #5, #3, #7. If there has the fifth symbol, the occupied RE in the fifth symbol is RE #2 obtained according to comb pattern with comb size 8. Thus, the AGC symbol between SCI2 and SL-PRS2 of UE2 should be a duplication of the fifth symbol.

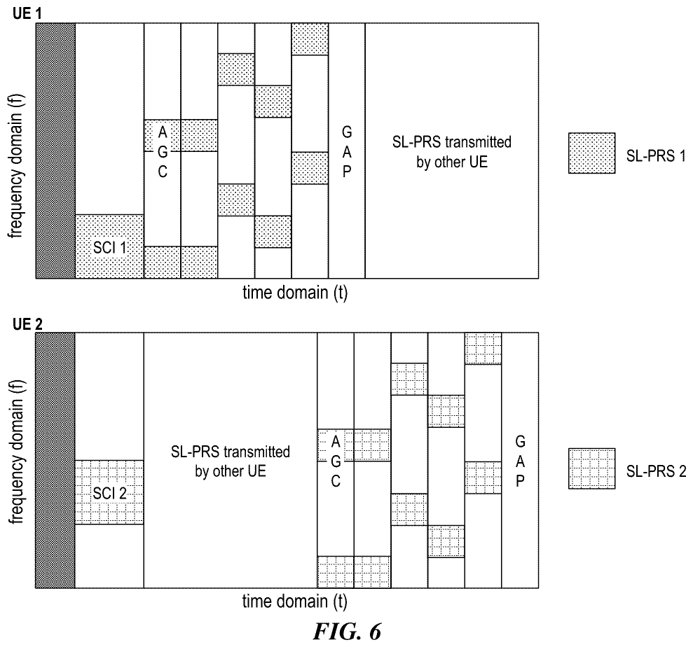

Under multiple transmission SL-PRS with fully staggered frequency pattern is multiplexed in TDM manner, FIG. 6 discloses an illustration of AGC design, where two transmission SL-PRS of two UEs is multiplexed in TDM manner and comb size of both the two SL-PRS are 4.

As disclosed in FIG. 6, UE1 transmits SL-PRS in SL-PRS resource 1, and UE2 transmits SL-PRS in SL-PRS resource 2. Because both of SL-PRS1 and SL-PRS2 are fully staggered, AGC symbol transmitted by UE1 is a duplication of the first symbol of SL-PRS1. and AGC symbol transmitted by UE2 is a duplication of the first symbol of SL-PRS2.

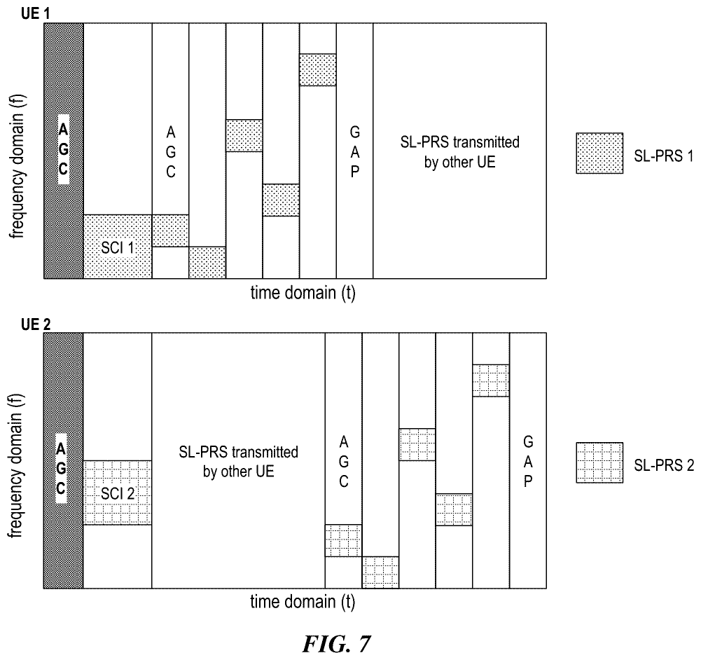

Under multiple transmission SL-PRS with partially staggered frequency pattern is multiplexed in TDM manner, FIG. 7 discloses an illustration of AGC design, where two transmission SL-PRS of two UEs is multiplexed in TDM manner and comb size of both the two SL-PRS are 8.

In FIG. 7, UE1 transmits SL-PRS in SL-PRS resource 1, and UE2 transmits SL-PRS in SL-PRS resource 2. Both of SL-PRS1 and SL-PRS2 are partially staggered pattern in frequency domain For both of UE1 and UE2, SL-PRS1 and SL-PRS2 occupy four symbols and RE #0, #4, #2, #6. If there has the fifth symbol, the occupied RE in the fifth symbol is RE #1 obtained according to comb pattern with comb size 8. Thus, the AGC symbol between SCI and SL-PRS of UE1 and UE2 should be a duplication of the fifth symbol.

### Embodiment 3

Based on Embodiment 1, in a dedicated SL-PRS resource pool, frequency resource occupied by multiple SCI is usually less than the bandwidth of SL-PRS resource.

To make full use of frequency resource and randomize interference, SCI frequency hopping is introduced.

Frequency resource occupied by SCI can be limited to a range of bandwidth of SL-PRS resource pool in a slot.

gNB or LMF or UE higher layer can configures/preconfigures a constant K, where K represents the frequency resource gap in the adjacent frequency hops.

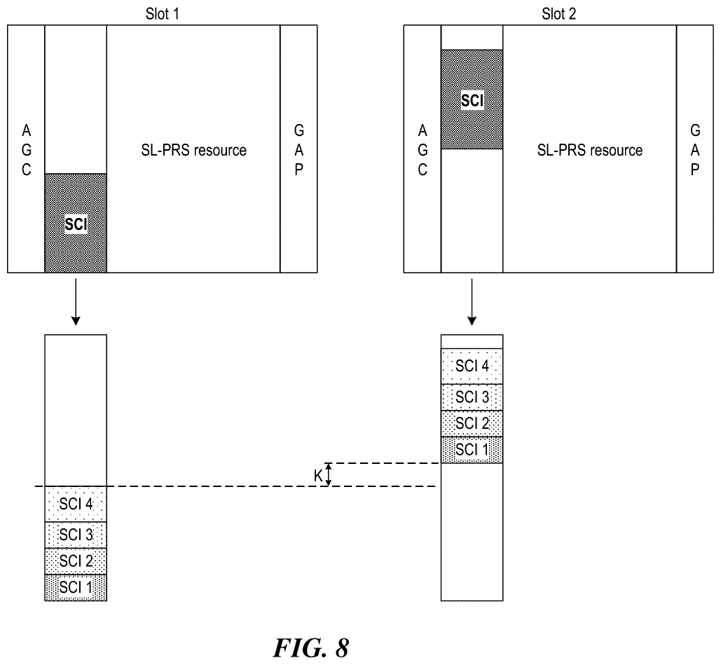

The unit of K can be PRB, RE, sub-channel or a frequency range. K should be not less than zero. For example, FIG. 8 gives an illustration on SCI hopping with K>0.

FIG. 8 discloses an example of SCI hopping with K>0. As shown in FIG. 8, the start location xₙ₊₁^{start} in frequency resource of frequency hop n+1 equals to the end location xₙ^{end} in frequency resource of frequency hop n plus K and plus one. In other words, xₙ₊₁^{start}=xₙ^{end}K+1 as shown in FIG. 8.

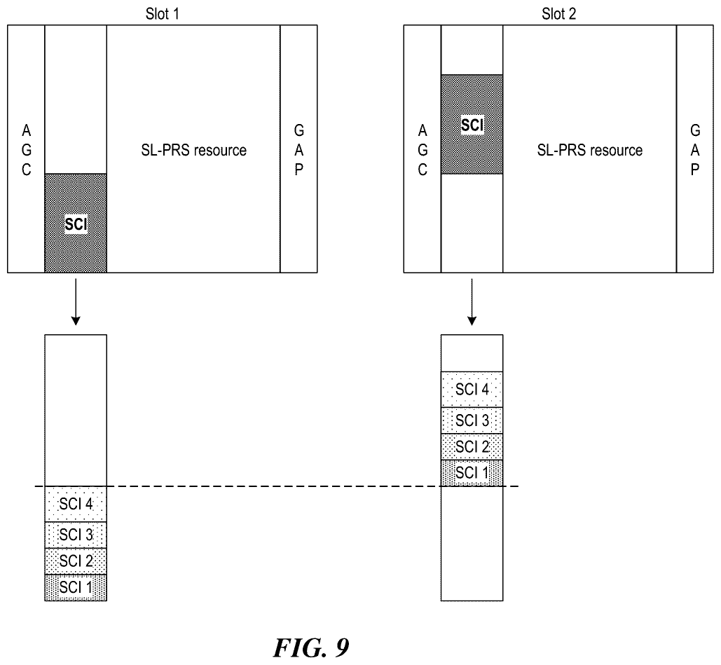

FIG. 9 discloses an example of SCI hopping with K=0. As shown in FIG. 9, when K=0, the start location xₙ₊₁^{start} in frequency resource of frequency hop n+1 is the next frequency unit of the end location xₙ^{end} in frequency resource of frequency hop n, where frequency unit can be PRB, RE, sub-channel or frequency range. In other words, xₙ₊₁^{start}=xₙ^{end}+1 when K=0.

### Embodiment 4

The bandwidth of SCI and SL-PRS are usually very different, which causes transmission power for SCI and SL-PRS may be different. This Embodiment aims to design transmission power of SCI.

One solution is to design transmission power spectrum density (PSD) of SCI is same as PSD of SL-PRS. For example, assume transmission power of SL-PRS is P_{SL-PRS}. PRB number of SL-PRS and SCI are noted as N_{SL-PRS} and N_{SCI}, respectively. Then, transmission power of SCI can be obtain by the following equation:

$${P}_{SCI} = 10 {log}_{10} ( {N}_{SCI} / {N}_{SL - PRS} ) + {P}_{SL - PRS} [ dBm ]$$

Alternatively, one enhanced solution is to introduce an offset for SCI transmission power based on the same PSD of SCI and SL-PRS, so as to control transmission power of SCI more flexible. The offset of SCI transmission power can be configured/preconfigured by gNB/LMF/UE higher layer. For example, transmission power of SCI can be obtain by the following equation:

$${P}_{SCI} = 10 {log}_{10} ( {N}_{SCI} / {N}_{SL - PRS} ) + {P}_{SL - PRS} + {Δ}_{SCI} [ dBm ] ,$$

where Δ_{SCI} is the offset of SCI transmission power.

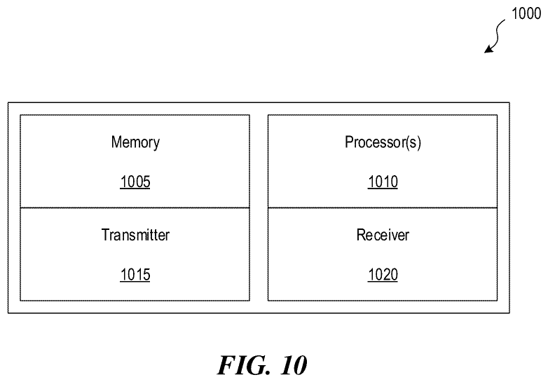

FIG. 10 shows an exemplary block diagram of a hardware platform 1000 that may be a part of a network device (e.g., base station) or a communication device (e.g., a user equipment (UE)). The hardware platform 1000 includes at least one processor 1010 and a memory 1005 having instructions stored thereupon. The instructions upon execution by the processor 1010 configure the hardware platform 1000 to perform the operations described in FIGS. 1 to 9 and 11 and in the various embodiments described in this patent document. The transmitter 1015 transmits or sends information or data to another device. For example, a network device transmitter can send a message to a user equipment. The receiver 1020 receives information or data transmitted or sent by another device. For example, a user equipment can receive a message from a network device.

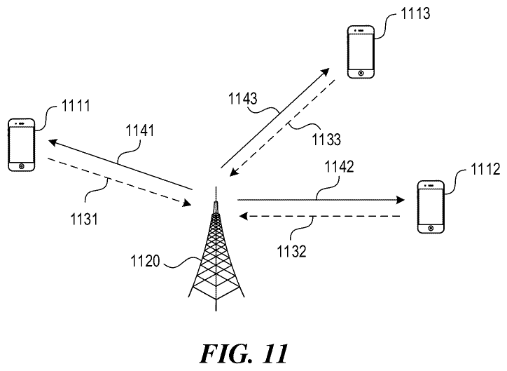

The implementations as discussed above will apply to a wireless communication. FIG. 11 shows an example of a wireless communication system (e.g., a 5G or NR cellular network) that includes a base station 1120 and one or more user equipment (UE) 1111, 1112 and 1113. In some embodiments, the UEs access the BS (e.g., the network) using a communication link to the network (sometimes called uplink direction, as depicted by dashed arrows 1131, 1132, 1133), which then enables subsequent communication (e.g., shown in the direction from the network to the UEs, sometimes called downlink direction, shown by arrows 1141, 1142, 1143) from the BS to the UEs. In some embodiments, the BS send information to the UEs (sometimes called downlink direction, as depicted by arrows 1141, 1142, 1143), which then enables subsequent communication (e.g., shown in the direction from the UEs to the BS, sometimes called uplink direction, shown by dashed arrows 1131, 1132, 1133) from the UEs to the BS. The UE may be, for example, a smartphone, a tablet, a mobile computer, a machine to machine (M2M) device, an Internet of Things (IoT) device, and so on.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. (canceled)

2. A method of wireless communication, comprising:
determining, by a first wireless communication device, a Sidelink Positioning Reference Signal (SL-PRS) resource according to an association between a resource for Sidelink Control Information (SCI) and the SL-PRS resource, where a transmission of the SCI indicates that a transmission of the SL-PRS is in a same slot; and
transmitting, by the first wireless communication device, the SCI and the SL-PRS to a second wireless communication device in a sidelink communication.

3. The method of claim 2, wherein the association is configured by a base station.

4. The method of claim 2, wherein the association between the SCI and the SL-PRS is determined by a list of indices indicating a frequency resource location in a slot, wherein there exists a one-to-one correspondence relationship between a first index corresponding to the SCI and a second index corresponding to the SL-PRS.

5. The method of claim 2, wherein frequency resources of a symbol proceeding the SL-PRS are determined based on a frequency pattern of the SL-PRS.

6. The method of claim 5, wherein the symbol is a duplication of one symbol of the SL-PRS.

7. An apparatus for wireless communication comprising at least one processor that is configured cause the apparatus to:
determine a Sidelink Positioning Reference Signal (SL-PRS) resource according to an association between a resource for Sidelink Control Information (SCI) and the SL-PRS resource, where a transmission of the SCI indicates that a transmission of the SL-PRS is in a same slot; and
transmit the SCI and the SL-PRS to a second wireless communication device in a sidelink communication.

8. The apparatus of claim 7, wherein the association is configured by a base station.

9. The apparatus of claim 7, wherein the association between the SCI and the SL-PRS is determined by a list of indices indicating a frequency resource location in a slot, wherein there exists a one-to-one correspondence relationship between a first index corresponding to the SCI and a second index corresponding to the SL-PRS.

10. The apparatus of claim 9, wherein frequency resources of a symbol proceeding the SL-PRS are determined based on a frequency pattern of the SL-PRS.

11. The apparatus of claim 10, wherein the symbol is a duplication of one symbol of the SL-PRS.

12. A non-transitory computer readable medium having code stored thereon, the code when executed by a processor, causing the processor to implement a method that comprises:
determining, by a first wireless communication device, a Sidelink Positioning Reference Signal (SL-PRS) resource according to an association between a resource for Sidelink Control Information (SCI) and the SL-PRS resource, where a transmission of the SCI indicates that a transmission of the SL-PRS is in a same slot; and
transmitting, by the first wireless communication device, the SCI and the SL-PRS to a second wireless communication device in a sidelink communication.

13. The non-transitory computer readable medium of claim 12, wherein the association is configured by a base station.

14. The non-transitory computer readable medium of claim 12, wherein the association between the SCI and the SL-PRS is determined by a list of indices indicating a frequency resource location in a slot, wherein there exists a one-to-one correspondence relationship between a first index corresponding to the SCI and a second index corresponding to the SL-PRS.

15. The non-transitory computer readable medium of claim 12, wherein frequency resources of a symbol proceeding the SL-PRS are determined based on a frequency pattern of the SL-PRS.

16. The non-transitory computer readable medium of claim 15, wherein the symbol is a duplication of one symbol of the SL-PRS.
